(19) United States
(12) Patent Application Publication
(10) Pub. No.: US 2011/0089688 A1
(43) Pub. Date: Apr. 21, 2011

(54) THREAD-LOCKABLE PIPE COUPLING ASSEMBLY

(76) Inventor: Yoav Nahmias, Tel Aviv (IL)

(21) Appl. No.: 12/808,689

(22) PCT Filed: Dec. 21, 2008
(86) PCT No.: PCT/IL2008/001646

§ 371 Date: Dec. 20, 2010

Related U.S. Application Data
(60) Provisional application No. 61/008,556, filed on Dec. 21, 2007.

(51) Int. Cl. F16L 21/02; F16B 37/16

(52) U.S. Cl. 285/367; 411/435

(57) ABSTRACT

A thread-lockable pipe coupling assembly and in particular to such an assembly wherein the pipe coupling is manually coupled by conical threading.

### FIELD OF THE INVENTION

The present invention relates to a thread-lockable pipe coupling assembly and in particular to such an assembly wherein the pipe coupling is manually coupled by conical threading.

### BACKGROUND OF THE INVENTION

Pipes made from either plastic or metal alloy are commonly used for irrigation, utility service lines such as gas, water and waste management, and other applications which require passage of a flowing fluid, liquid, gas or solution under pressure.

Pipe saddles are used to form various connections or branches from a main or primary pipe, without requiring removal of an already installed pipe. They are convenient in that it can be expensive and difficult, if not impossible, to disassemble pipe installations in order to add such a junction, for example for agricultural irrigation systems.

However, pipe saddles used in the art are of bulky construction and cannot be readily manually attached without the use of tools. The installation of joints, T-joints, taps and valves in the main lines requires tools and handling of a number of parts.

US Patent Publication No. 2006/0151997 to Sayers et al teaches a conduit saddle comprising two parts that fit around a pipe that are attached via a bolt or allen screw. The split saddle taught by Sayers does not allow for a quick and manual installation of the saddle on the main pipe. Currently only such inconvenient pipe saddle constructions are known in the art.

### SUMMARY OF THE INVENTION

The background art does not teach or suggest a coupling assembly that may be easily, quickly and manually installed, thereby allowing the coupling and branching of a main pipeline carrying a flowing fluid without requiring the use of special tools.

The present invention overcomes these deficiencies of the background art by providing a manually threadable pipe coupling assembly, for example including but not limited to a pipe coupling, split saddle pipe coupling, split structure coupling or the like, that preferably may be easily, quickly and securely fit onto a main pipeline while accommodating its working pressure. Without wishing to be limited in any way, among the constructions for which such a pipe coupling are useful include branching pipes, cornering pipes, T-junctions, X-junction, fixing plug, pipe coupling or the like and/or split saddle pipe coupling or junctions known and accepted in the art.

Applications for which such pipes are useful include any type of application involving fluid flow, preferably under pressure. As used herein, the term “fluid” includes but is not limited to any liquid, gas or solution. Illustrative applications include but are not limited to agricultural applications such as irrigation, residential pipe installation, industrial pipe installation, water treatment, mining, waterworks and the like.

Within the context of this application the terms threaded extensions, male joining members, split bolt construct or male connector may be used interchangeably to refer to male joining constructs or connectors optionally and preferably extending from a coupling body most preferably having external threading.

Within the context of this application the terms nut, wing nut, and fastener may be used interchangeably to refer to a fastener providing the female connector preferably having internal threading optionally for coupling at least two or more male joining members.

A preferred embodiment of the present invention provides for a coupling assembly, for example including but not limited to a split saddle pipe coupling, pipe coupling, split structure coupling or the like, comprising a plurality of sections, more preferably an upper section and a lower section, that are preferably securely fastened to each other using at least one or more threadable fasteners, more preferably wing nut(s). It should be noted that by “upper” and “lower” it is meant that the sections are preferably disposed at opposing sides of the pipe, although absolute diametric opposition is not required.

Preferably, the inner surface of the wing nut comprises threading that allows the fastening of the upper and lower saddle sections together. The upper and lower saddle portions respectively comprise at least one or more, threaded extensions that are perpendicular to the body of the saddle portion. Most preferably, the lower and upper saddle portions individually comprise a plurality of threaded extensions on parallel sides of the saddle portion extending perpendicularly to the saddle body. Preferably, the threaded extensions, when aligned one on top of the other, provide a threaded bolt onto which the fastener is fastened with the corresponding threading.

Preferably, the upper and lower portions may be aligned with each other using a plurality of male and female connectors. Optionally, the upper portion comprises a plurality of either only male or only female connectors while the corresponding lower portion comprises the corresponding male or female connectors. Optionally the lower portion comprises a plurality of male and/or female connectors while the upper portion has the corresponding mix of male and/or female connectors.

An optional embodiment of the present invention provides for a split saddle pipe coupling assembly comprising an upper saddle portion and a lower saddle portion, wherein at least one of the saddle portions is integrated with a pipe fitting portion. Optionally and preferably the pipe fitting portion is used to form various branching and connections from a main pipe through the split saddled assembly according to the present invention. Optionally, the integrated pipe fitting portion for example includes but is not limited to a barb connector, an internally threaded pipe fitting, an externally threaded pipe fitting, T-Joint, X-Joint, compression fitting, nut lock fitting, or the like pipe fitting used to branch or connect pipe.

A preferred embodiment according to the present invention the upper and lower portion of the split saddle may optionally be the same, or different. Optionally, at least one or both of the lower and upper portions may comprise an integrated pipe fitting and seal. Optionally, at least one or both the lower and upper portions may comprise a saddle pipe fitting without a further pipe fitting integrated thereto. Optionally, at least one of the upper or lower split saddle portions is integrated with a pipe fitting and seal, while the corresponding upper or lower split saddle portion is not integrated with a pipe fitting and acts as a saddle.

An optional embodiment of the present inventions provides for a hinged split saddle pipe coupling assembly that is securely coupled over a pipe with at least one or more threaded wing nut(s). Preferably, the upper and lower portion are joined over a hinge at one face while on the parallel face the upper and lower portions are coupled with at least one or more threaded wing nuts. Preferably, the threaded wing nuts securely lock couple the upper and lower portions of the split saddle pipe coupling assembly, over a pipe, according to the present invention.

A further optional embodiment of the present invention provides for a split saddle pipe coupling assembly that is securely coupled over a pipe, optionally using at least one or more threaded wing nuts. Most preferably, a plurality of parallel wing nuts are used to securely lock and couple an upper and a lower saddle portions over a pipe (most preferably two such wing nuts), wherein at least two wing nuts are most preferably located at opposite sides of the saddle assembly.

Optionally and preferably, an equal number of a plurality of threaded wing nuts are used to couple opposite sides of upper and lower portions of the split saddle assembly, for example one, two or more on each side of the saddle assembly. Optionally, an unequal number of a plurality of threaded wing nuts are used to couple opposite sides of upper and lower portions of the split saddle assembly. As an example of the latter, a first side of each of the upper and lower portions of the split saddle may optionally be coupled over a pipe, for example using a first threaded wing nut, or hinge; while a second side, parallel to the first side, is optionally coupled using a plurality of wing nuts. This combination forms a split saddle assembly, wherein a single wing nut is used to couple the first side of the split saddle, while the second side features two or more wing nuts to securely couple the upper and a lower saddle portions.

Optionally, a plurality of saddles may be used to saddle a pipe, with upper and lower portions. Optionally, pipes having larger diameters may require a plurality of saddle portions to completely saddle its circumference. For example, each saddle portion may be used to cover a portion of the pipe circumference. For example, three saddle portions may be combined to cover one pipe, wherein each saddle covers a third of the pipe circumference. As another non-limiting example, a large pipe may be saddled optionally using four saddle portions optionally wherein each saddle portion covers a quarter of the pipe circumference. As yet another non-limiting example, three saddle portions may be combined to cover one pipe, wherein one saddle portion covers half of the pipe's circumference while two portions each cover a quarter of the pipe's circumference to fully saddle the pipe.

Optionally, each saddle portion used to saddle the pipe may comprise a different functional unit, for example including but not limited to a barb connector, an internally threaded pipe fitting, an externally threaded pipe fitting, T-Joint, X-Joint, compression fitting, nut lock fitting, or the like pipe fitting used to branch or connect a pipe.

Preferably, the integrated pipe fitting portion further comprises a seal to prevent leakage at the pipe joint. Optionally the seal comprises an o-ring, gasket, or the like seal to prevent leakage at the junction between pipe fitting, the main pipe, the split saddle assembly of the present invention or the like. Optionally the seal is composed of rubber, latex, plastic metal, metal alloy, Teflon, Viton®, hardening foam, foam, fiberglass or the like.

Optionally, the split saddle assembly of the present invention comprises a plastic material optionally including but not limited to PVC, nylon, polypropylene, polyethylene, acrylic, plastic having a glass fiber additive, or the like. Optionally the split saddle assembly of the present invention may be composed of metal or metallic alloys, or the like. A combination of such materials may also optionally be used. Other suitable materials may optionally be used, additionally or alternatively.

The split saddle pipe assembly according to the present invention may preferably allow the branching of a main pipe that contains a flowing fluid. Optionally, the flowing fluid includes but is not limited to: a liquid, gas, solution or the like flowing fluid.

An optional embodiment according to the present invention provides for a pipe coupling assembly comprising the upper and lower portion of the split saddle may optionally be the same, or different. Optionally, at least one or both of the lower and upper portions may comprise an integrated pipe fitting and seal. Optionally, at least one or both the lower and upper portions may comprise a saddle pipe fitting without a further pipe fitting integrated thereto. Optionally, at least one of the upper or lower split saddle portions is integrated with a pipe fitting and seal, while the corresponding upper or lower split saddle portion is not integrated with a pipe fitting and acts as a saddle.

Optionally and preferably, the pipe coupling assembly of the present invention provides for a conically shaped wing nut that is preferably used to fasten an upper and a lower portion of a pipe coupling for example including but not limited to a split saddle pipe coupling assembly. Optionally, the winged nut may be cylindrical. The body, or nut portion, of the winged nut according to the present invention preferably has an increasing diameter. Preferably, the wing nut's largest diameter is proximal to the saddle body while the smallest diameter is distal to the saddle body. The wing nut having a sequentially increasing diameter, from the saddle or pipe body, provides for a lockable pipe coupling assembly for example including but not limited to a split saddle pipe coupling. Most preferably, the internal threading of the wing nut comprises conically shaped threading comprising sequentially increasing diameter. Preferably, the internal threading of the wing nut has its largest diameter proximal to the pipe coupling body while the smallest diameter is distal to the pipe coupling body.

Optionally and preferably, the wing nut comprising internal conical threading according to the present invention may be provided in a plurality of varying external shapes for example including but not limited to hexagonal, octagon, square, cylindrical, ellipsoid or the like nut shape as is known and accepted in the art.

Optionally the wing nut according to the present invention may comprise gear work teeth wherein the gear work teeth are optionally disposed on its external or internal surface. Optionally and preferably, gear work teeth provide a further locking measure. Most preferably, the gear work teeth associate with a corresponding stopper member preferably disposed on at least one portion of the coupling body or surface for example including but not limited to split saddle body, pipe coupling body, threaded extensions, male joining member, pipe, structure or the like.

Optionally, gear work teeth may be disposed on the internal surface of the wing nut such that the teeth point internally, having a corresponding stopper on the surface of the coupling assembly. Optionally, gear work teeth may be disposed on the external surface of the wing nut such that the teeth point externally, having a corresponding stopper on the surface of the coupling assembly. Optionally, gear work teeth may be disposed on either or both of the internal or external surface such that at least one or more teeth point internally and at least one or more teeth point externally each comprising a corresponding stopper on the surface of the coupling assembly.

An optional method is provided according to some embodiments of the present invention wherein a split saddle pipe coupling assembly is coupled to a pipe, the method comprising: placing an upper saddle portion against the main pipe; placing a lower saddle portion against the main pipe; aligning the lower and upper saddle portions on the main pipe with the female and male connectors; fastening the upper and lower saddle portions with at least two wing nuts at the sides of the split saddle, preferably at parallel sides.

A further optional method is provided according to some embodiments of the present invention wherein a split saddle pipe coupling assembly is coupled to a pipe and then branched with an additional pipe fitting, the method comprising: placing upper saddle portion against the main pipe; placing lower saddle portion against the main pipe; aligning the lower and upper saddle portions on the main pipe with the female and male connectors; fastening the upper and lower saddle portions with at least two wing nuts at the sides of the split saddle, preferably at parallel sides; and adding a branched pipe fitting to at least one of the upper or lower saddle portions.

An optional embodiment of the present invention provides for a conically shaped thread-lockable split bolt and nut coupling construct for coupling at least two portions of a structure. Most preferably, the conically shaped thread-lockable split bolt construct, comprise external threading, are preferably disposed on at least two portions of a structure that may be coupled by corresponding conically shaped internal threading disposed on the inner surface of a nut. Optionally and preferably, the nut takes the form of a wing nut to allow for manual coupling. Most preferably the split bolt construct forms a pair of male joining member that correspond to one another and are preferably disposed on corresponding portions of a structure to be coupled. Optionally the split bolt construct is formed from at least two or more corresponding male joining members that correspond to one another to form a single bolt construct and are preferably disposed on corresponding portions of a structure to be coupled. Optionally and preferably the split bolt construct is formed from at least two and up to four corresponding male joining members that correspond to one another to form a single conical bolt construct and are preferably disposed on corresponding portions of a structure to be coupled.

Most preferably, the split bolt portions are fixed to a structure to be coupled on corresponding portions. Preferably, the location and disposition of the split bolt structure is variable and controllable, most preferably its location is dependent on parameters associated with the structure itself for example including but not limited to at least one or more of the following parameters: utility, function, size, shape or the like.

Most preferably, the corresponding nut is most preferably amenable for manually coupling a pair of split bolt constructs, optionally the nut may be manipulated by standard tools as is known and accepted in the art. Optionally and preferably, the nut comprising internal conical threading according to the present invention may be provided in a plurality of varying external shapes for example including but not limited to hexagonal, octagon, square, ellipsoid or the like nut shape as is known and accepted in the art. Most preferably, the internal threading of the nut comprises conically shaped threading comprising a sequentially increasing diameter. Preferably, the internal threading of the nut has its largest diameter proximal to the coupled construct while the smallest diameter is distal to the coupled construct.

Optionally the nut according to the present invention may comprise gear work teeth wherein the gear work teeth are optionally disposed on its external or internal surface. Optionally and preferably, gear work teeth provide a further locking measure. Most preferably, the gear work teeth associate with a corresponding stopper member preferably disposed on at least one portion or surface of the coupling structure for example including but not limited to split saddle, pipe coupling, split bolt construct or the like.

Optionally, gear work teeth may be disposed on the internal surface of the nut such that the teeth point internally, having a corresponding stopper on the surface of the coupling structure. Optionally, gear work teeth may be disposed on the external surface of the wing nut such that the teeth point externally, having a corresponding stopper on the surface of the coupling structure or split bolt construct. Optionally, gear work teeth may be disposed on either or both of the internal or external surface such that at least one or more teeth point internally and at least one or more teeth point externally each comprising a corresponding stopper on the surface of the coupling structure or split bolt construct.

Unless otherwise defined, all technical and scientific terms used herein have the same meaning as commonly understood by one of ordinary skill in the art to which this invention belongs. The materials, methods, and examples provided herein are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an exemplary schematic diagram of an exemplary assembly according to the present invention;

FIGS. 2A-D are exemplary schematic cross sectional diagrams of the assembly according to the preferred embodiment of the present invention; and

FIGS. 3-10 show exploded views of different embodiment of the split saddle pipe coupling assembly according to optional embodiments of the present invention.

### DESCRIPTION OF THE PREFERRED EMBODIMENTS

The present invention is of a system and a method for split saddle pipe coupling assembly preferably having a threaded fastening assembly to join the split saddle portions over a pipe. More preferably the threaded fastening assembly comprises wing nuts over threaded protrusions from the saddle portions.

The principles and operation of the present invention may be better understood with reference to the drawings and the accompanying description.

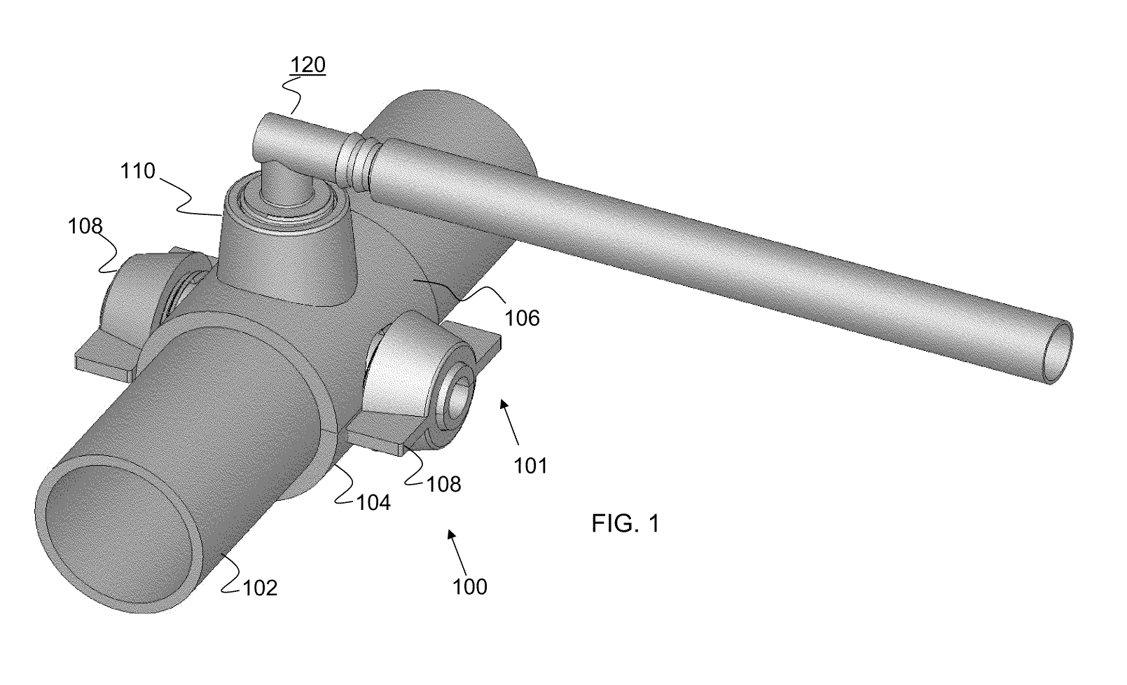

Referring now to the drawings, FIG. 1 depicts a pipe assembly 100 according to an optional embodiment of the present invention. Main pipe 102 allows a fluid, for example including any of a liquid, gas, or solution, to flow through its lumen along its length. FIG. 1 shows main pipe 102 having a branched fitting 120 that extends from pipe 102 as an exemplary embodiment. Fitting 120 is attached or connected to pipe 102 with a split saddle assembly 101 comprising at a plurality of threaded wing nuts 108, preferably having a conical shape; a lower portion 104; and an upper portion 106, optionally having a threaded T-joint 110 through which fitting 120 is threaded. Preferably, two threaded wing nuts 108 are used to securely fasten and couple the split saddle lower portion 104 and upper portion 106 over pipe 102. Internal threading (not shown) of wing nut 108 is preferably coupled with the external threading (not shown) projecting from lower portion 104 and upper portion 106 respectively. Fitting 120 is coupled to split saddle assembly 101 via the internal threading (not shown) of T-joint 110.

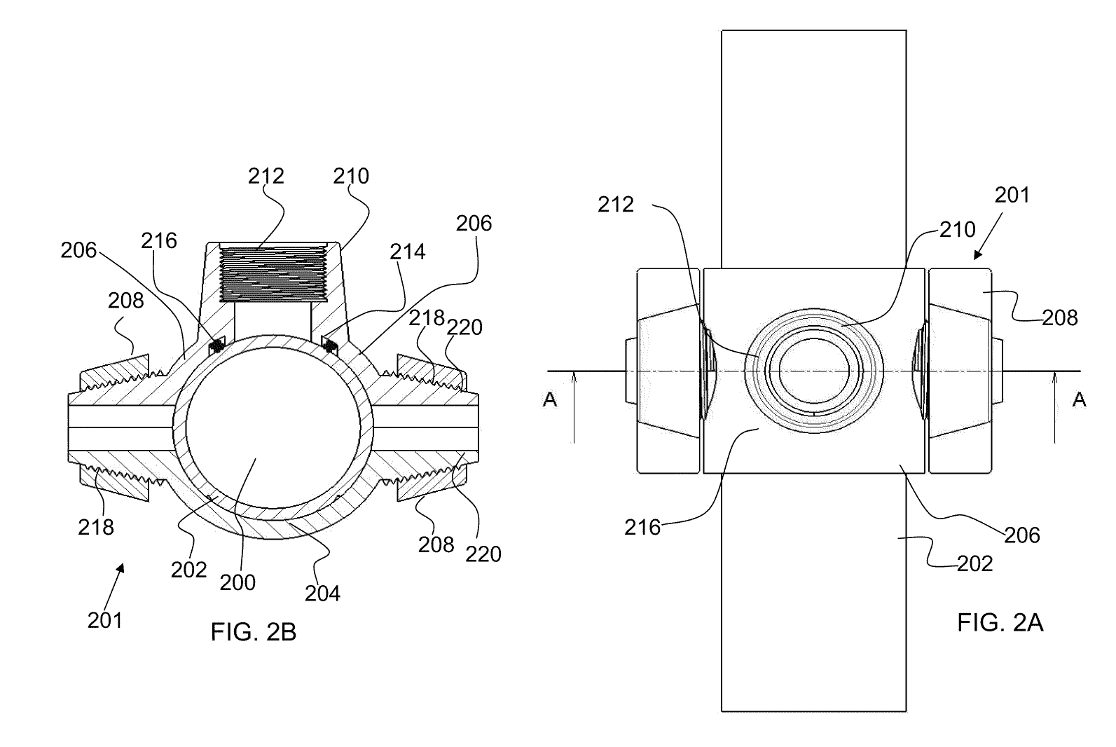

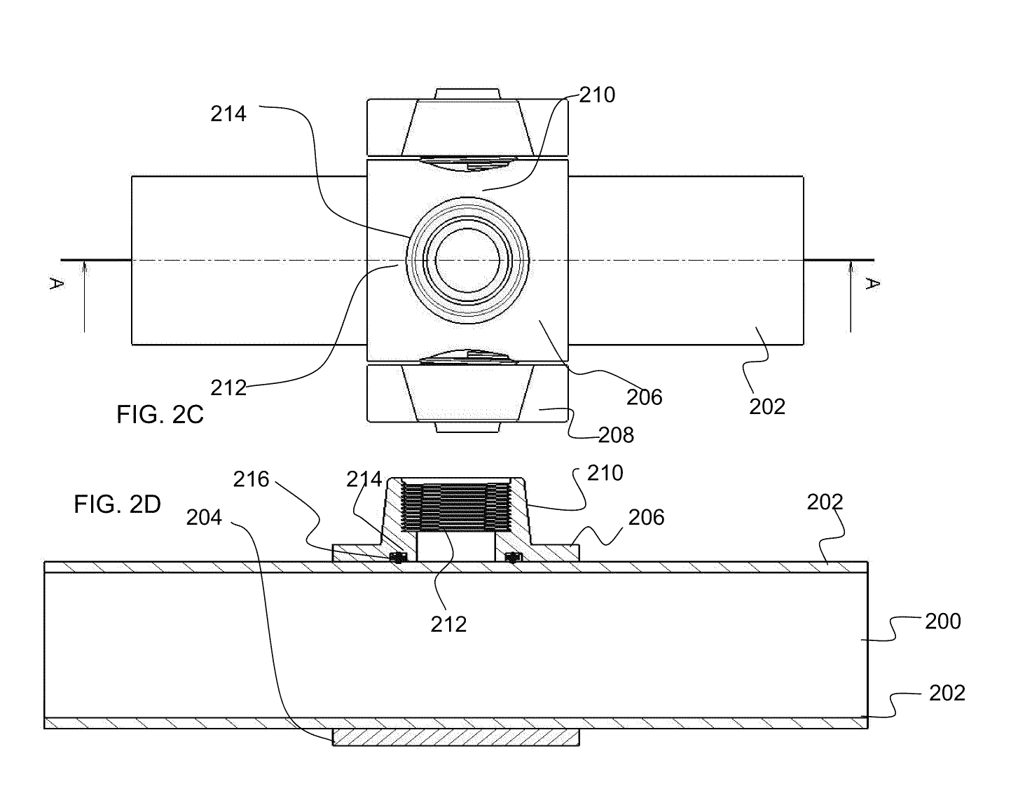

The split saddle assembly 101 of FIG. 1 is shown in different views in FIGS. 2A-2D. FIGS. 2A and 2C depict top views of an optional pipe assembly according to an optional embodiment of the present invention where main pipe 202 has a split saddle assembly 201 attached thereto. Pipe 202 and split saddle assembly 201 are preferably securely coupled with a plurality of threaded wing nut 208. T-Joint 210 extends from the upper portion 206 and is preferably integrated thereto. T-Joint 210 optionally comprises internal threading 212 through which fittings (not shown) may be connected and a seal 216. Optionally, seal 216 may be a gasket, o-ring or the like.

FIG. 2B is a cross-sectional view of FIG. 2A through section A-A. Pipe 202 is saddled using the split saddle assembly 201 according to an optional embodiment of the present invention. Pipe 202 is preferably saddled with lower saddle portion 204 and upper saddle portion 206. Preferably wing nut 208 securely couples lower saddle portion 204 and upper saddle portion 206 over pipe 202. Preferably, wing nut 208 has internal threading 218 that securely binds to and/or is matched to and/or connects with external threading 220 on the joining portion 222 extending from both the lower saddle portion 204 and upper saddle portion 206. Most preferably the shape of wing nut 208 and joining portion 222 correspond to one another in a female/male manner, that further allows the snug fit of corresponding internal threading 218 of wing nut 208 to the external threading 220 of male joining portion 222. Optionally, wing nut 208 and joining portion 222 have the same or a similar shape preferably including but not limited to a conical shape, or the like.

Upper saddle portion 206 optionally comprises a T-Joint member 210 that is preferably integrated with upper saddle portion 206. Seal 216 is preferably placed within recess 214 and seals the connection between pipe 202 and T-joint member 210. T-joint 210 preferably comprises an internal threading 212 to allow the attachment of threadable member for example including but not limited to a pipe, irrigation system, water works, mining, water treatment or the like.

FIG. 2D presents a cross section view of FIG. 2C through section A-A, cut along the length of the pipe 202 exposing its lumen 200. Lower saddle portion 204 and upper saddle portion 206 preferably saddle pipe 202. Seal 216 placed within recess 214 seals the connection between pipe 202 and T-joint portion 210. Optionally, seal 216 is gasket, o-ring or the like as known and accepted in the art to seal the connection between pipe 202 and upper saddle portion 206. T-joint 210 preferably comprises internal threading 212 on the inner face of T-joint 210. Threading 212 optionally and preferably allows for coupling of further threaded piping connections to pipe 202.

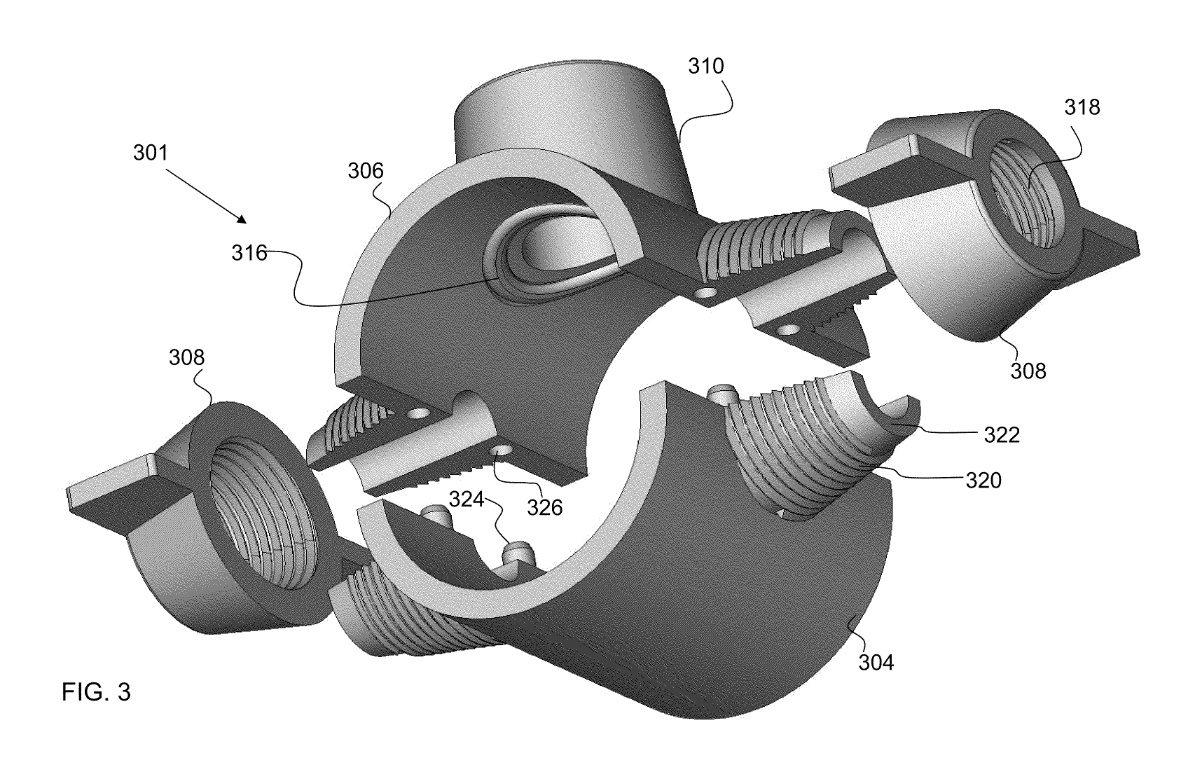

FIG. 3 depicts an exploded view of an optional embodiment of the split saddle assembly 301 according to the present invention. T-joint 310 is optionally and preferably integrated within upper saddle portion 306. Preferably upper saddle portion comprises a seal 316. Preferably both upper saddle portion 306 and lower saddle portion 304 individually each comprise a threadable male joining member 322 that has external threading 320. Preferably external threading 320 corresponds to the internal threading 318 of wing nut 308, allowing the coupling of lower saddle portion 304 and upper saddle portion 306.

Optionally and preferably a plurality of male connectors 324 and female connectors 326 are utilized to align and connect upper saddle portion 306 and lower saddle portion 304. Optionally, male connectors 324 and female connectors 326 are located on either side of the split saddle assembly, having a connector around the pipe (not shown)

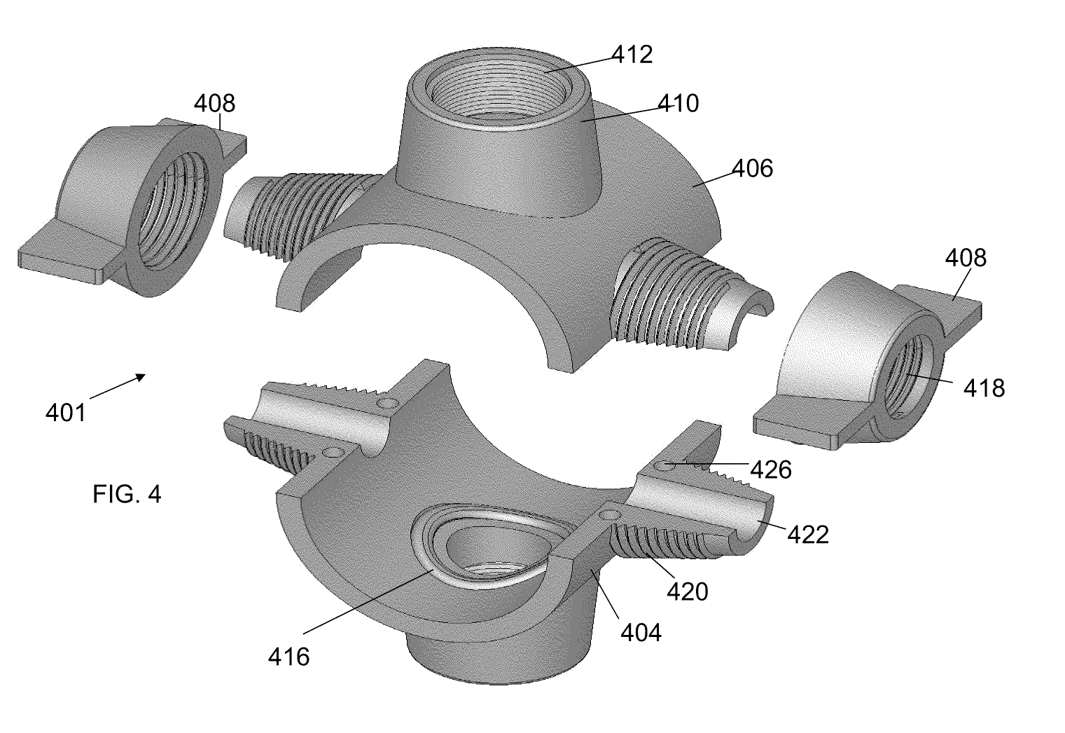

FIG. 4 depicts an exploded view of an optional embodiment of the present invention for a double T-joint split saddle pipe coupling assembly 401. Optionally both upper portion 406 and lower portion 404 may comprise any connector or joint type for example including but not limited to joint, ball joint, X-junction, fixing plug, pipe coupling, nut lock, irrigation or the like.

FIG. 4 depicts a double T joint assembly 401 where the upper portion 406 and lower portion 404 each comprise an integrated T-joint 410 each preferably having an internal threadable surface 412 that may be adjoined to other threadable fittings, for example including but not limited to an irrigation pipe or the like. Optionally, alignment between upper saddle portion 406 and lower saddle portion 404 is achieved with male connectors (not shown) that fit snugly into female connectors 426 to bring upper portion 406 and lower portion 404 together. Preferably, each of the upper portion 406 and lower portion 404 comprise an extendable male connector 422 optionally and preferably having external threading 420. Preferably, two connectors 422 each from the upper saddle portion 406 and lower saddle portion 404 are securely coupled with wing nut 408. Internal threading 418 and external threading 420 fasten upper saddle portion 406 and lower saddle portion 404 in a secure manner.

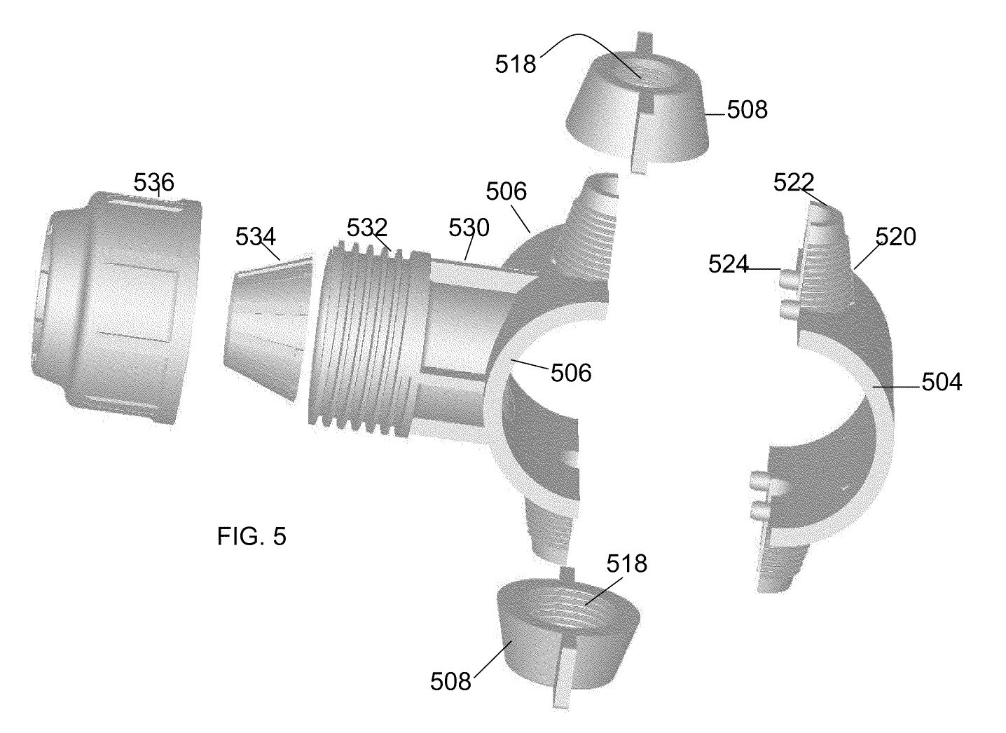

FIG. 5 depicts an exploded view of the split saddle pipe coupler according to an optional embodiment of the present invention having an integrated pipe coupling portion with an external threading assembly. Lower portion 504 and upper portion 506 saddle a pipe (not shown) by aligning male connectors 524 with corresponding female connectors (not shown). Additionally, wing nut 508, preferably with threading 518 on an internal surface as shown, is threaded onto the external threading 522 extending from upper saddle portion 506 and lower saddle portion 504, thereby preferably fastening and forming a seal between upper saddle portion 506 and lower saddle portion 504.

Upper portion 506 optionally further comprises a T-Joint 530 having external threading 532 that may optionally be fit with other connectors, preferably using nut 536 and grip ring 534 as shown.

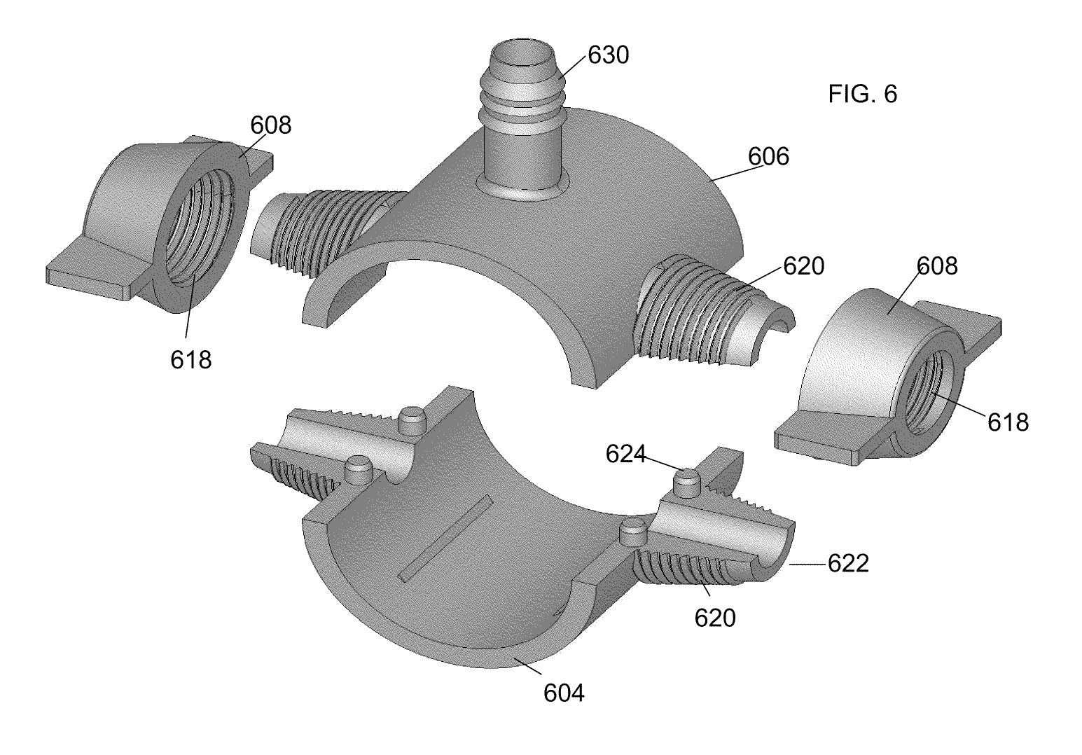

FIG. 6 depicts an exploded view of the split saddle pipe coupler according to the present invention having an integrated pipe coupling in the form of a barb connector, similar to FIG. 3 and FIG. 5. The connection using the threaded wing nut 608 with extended portion 622 from both the upper portion 606 and lower portion 604 forms the split saddle assembly of the present invention. The optional pipe fitting assembly integrated with upper portion 606 is a barb rapid connector 630 that allows quick connection and coupling of piping joints.

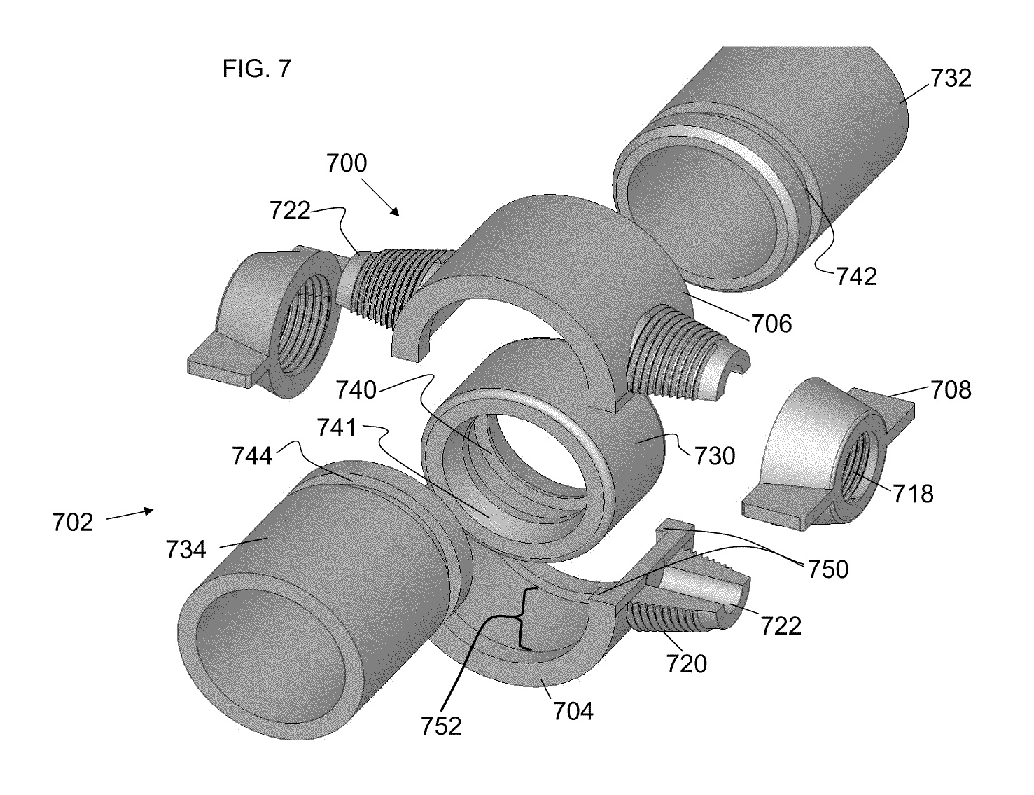

FIG. 7 depicts an exploded view of the split saddle pipe coupler according to an optional embodiment of the present invention, comprising grooved pipe coupling assembly 702 and a thread-lockable split saddle assembly 700. Grooved pipe coupling assembly 702 comprises a gasket 730 having a groove 740 able to couple with two grooved pipe sections, 732 and 734. First grooved pipe section 732 has a shoulder 742 while second grooved pipe section 734 has a shoulder 744. Gasket 730 is coupled to first pipe section 732 by placing first pipe section shoulder 742 within gasket 730, preferably within groove 740, forming a sealed pipe coupling between gasket 730 and first pipe section 732. Similarly, gasket 730 is coupled to second pipe section 734 by placing second pipe section shoulder 744 in gasket 730, preferably within groove 740, forming a sealed pipe coupling between gasket 730 and first pipe section 734, and completing grooved pipe coupling assembly 702.

Preferably, split saddle assembly 700 saddles pipe assembly 702 over gasket 730. Split saddle assembly 700 comprises saddle upper portion 706 and lower portion 704, that are preferably securely fastened over gasket 730 by threading a plurality of wing nuts 708 having internal threading 718 with external threading 720, thereby coupling saddle upper portion 706 to lower portion 704 via the respective male joining members 722.

Preferably, gasket 730 is securely housed on shoulders 742 and 744. Shoulders 750 within each of the split saddle upper portion 706 and lower portion 704 preferably enter the grooves 752 of grooved pipe sections 732 and 734. Preferably, the width of grooves 752 corresponds to the width of shoulders 750, allowing a sealable fit between split saddle assembly 700 and pipe assembly 702.

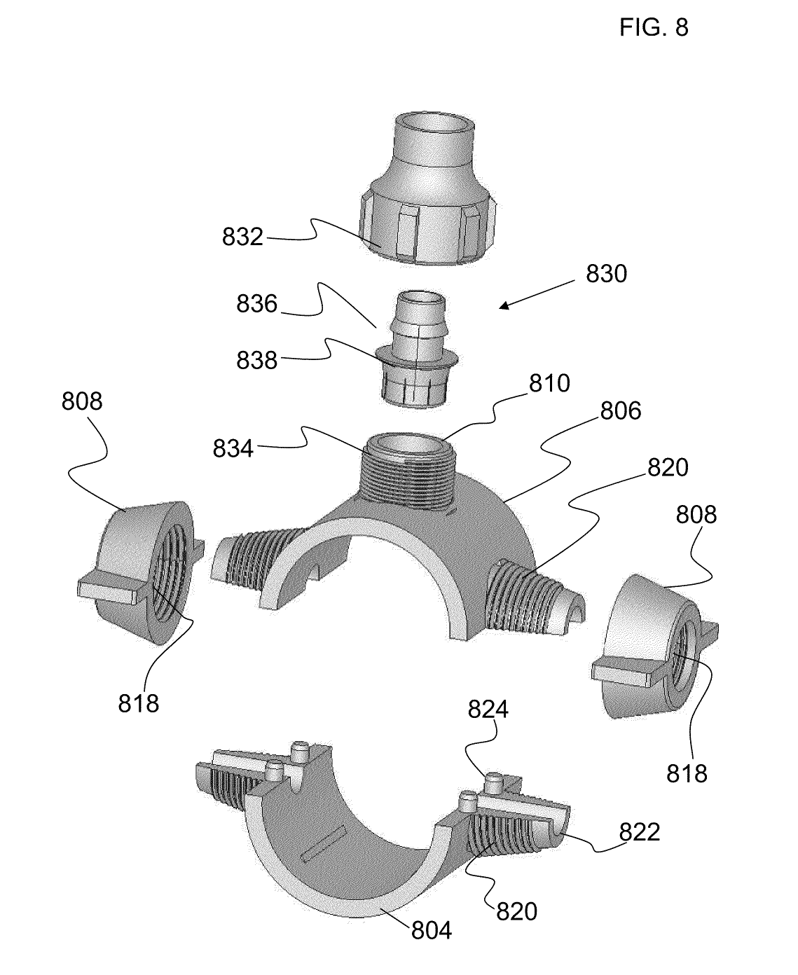

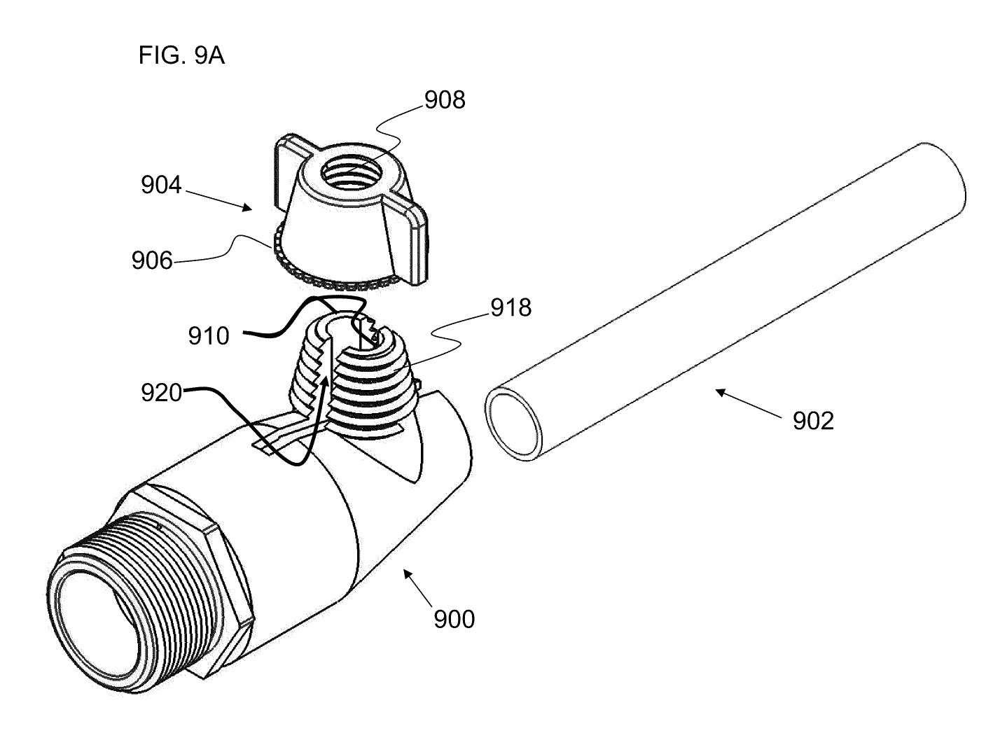

FIG. 8 depicts an exploded view of the illustrative, exemplary embodiment of a split saddle pipe coupler according to the present invention having an integrated pipe coupling in the form of nut lock connector 830, similar to FIG. 3 and FIG. 5. The connection using threaded wing nut 808 with extended portion 822 from both the upper portion 806 and lower portion 804 forms the split saddle assembly of the present invention. The optional pipe fitting assembly integrated with upper portion 806 is preferably a nut lock connector assembly 830 comprising external connector 836 that is fit into T-joint section 810 and securely placed using stopper 838. T-Joint section 810 has external threading 834 that is threaded with the internal threading (not shown) of nut 832 covering connector 836. Nut 832 preferably provides a further optional connection, coupling and branching of various piping joints.

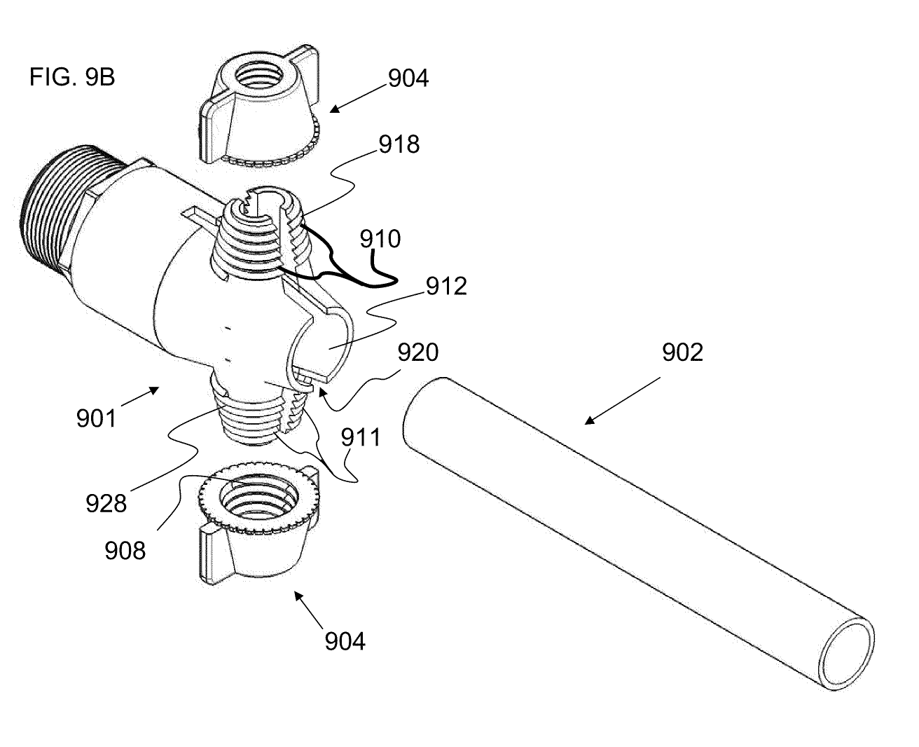

FIGS. 9A and 9B provide similar depiction of a pipe coupling assembly according to the present invention comprising similar part having similar function and use. Similar numbers and labels are therefore used to depict such similar functioning members.

FIG. 9A depicts an exploded view of an illustrative, exemplary embodiment of a pipe coupling according to the present invention wherein pipe 902 may be coupled to pipe coupler 900 comprising a split saddle according to the present invention separated over an opening 920. Opening 920 disposed on pipe coupling 900, preferably provides for accepting a plurality of optional pipes 902 having varying diameters. A preferred embodiment of the present invention provides a manual coupler comprising at least two split bolt member 910 that may be securely joined and locked over opening 920 with nut 904. Most preferably, nut 904 is a wing nut amenable to manual manipulation and coupling of corresponding split bolt members 910. Optionally, nut 904 may be provided in a plurality of shapes that are amenable for manipulation with tools as is known and accepted in the art. Most preferably, split bolt members 910 comprise external threading 918 corresponding to internal threading 908 disposed on the inner surface of coupling nut 904. Optionally, nut 904 may be provided with a gear work teeth 906 optionally as a further safety locking measure having at least one or more corresponding stop member (not shown) preferably on at least one or both halves of the pipe coupling members.

Pipe coupling depicted in FIG. 9A according to the present invention is preferably achieved when pipe 902 is placed within split saddle coupler 900 within opening 912 (see FIG. 9B), therein forming and defining the coupling distance over opening 920 between corresponding split bolt members 910. Split bolt member 910 comprising external threading 918 are threaded and interlocked with internal threading 908 disposed on the inner surface of nut 904 therein securely coupling split saddle coupler 900 with pipe 902.

FIG. 9B depicts split saddle coupler 901 similar to that depicted in FIG. 9A however it comprises comprising two split saddles separated over opening 920 situated on opposite sides of coupler 901. Upper split bolt members 910 comprising external threading 918 may be thread-locked with a first nut 904 within internal threading 908. While lower split bolt members 911 comprising external threading 928 may be similarly thread-locked with a second nut 904 within internal threading 908, to form secure bond between pipe 902 and pipe coupler 901.

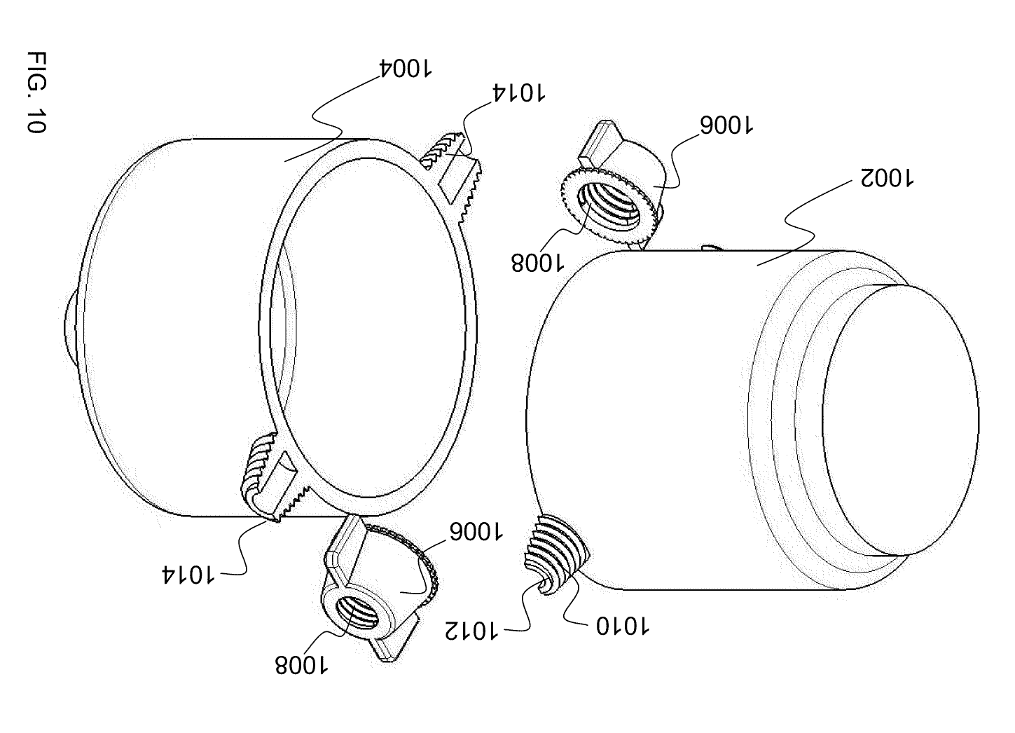

FIG. 10 depicts an exploded view of a filter housing comprising an upper portion 1002 and a lower portion 1004 that are fit with the split bolt coupling according to an optional embodiment of the present invention, most preferably having a conical shape. Preferably, filter housing upper portion 1002 and lower portion 1004 are securely coupled over at least one upper threadable male joining member 1012 and at least one lower threadable male joining member 1014 each comprising external threading 1010. Most preferably, male joining members 1012 and 1014 are fasted with wing nut 1006 comprising internal threading 1008 corresponding external threading 1010. Filter housing upper portion 1002 and lower portion 1004 may optionally and preferably comprise at least one or more pair of male joining member 1012 and 1014. Optionally and preferably, the number male joining member pairs used to couple at least two portions of a structure depend on parameters associated with the structure for example including but not limited to at least one or more of the following parameters: utility, function, size, shape or the like.

While the invention has been described with respect to a limited number of embodiments, it will be appreciated that many variations, modifications and other applications of the invention may be made.

1. A split saddle pipe coupling assembly comprising
a. an upper saddle portion having an extension;
b. a lower saddle portion having an extension;
c. a fastener to externally fasten said extensions of said upper and lower saddle portions.

2. The split saddle assembly of claim 1 wherein said extensions are externally threaded and wherein said fastener comprises a wing nut having threading on its internal surface.

3. The split saddle assembly of claim 2 wherein
a. said upper saddle portion and said lower saddle portions each further comprise two external threaded extensions that are on parallel sides of the saddle body and extend perpendicularly to the saddle body; and
b. said wing nut further comprises threading on its internal surface.

4. The split saddle assembly according to claim 3 further comprising male and female connectors.

5. The split saddle assembly of claim 3 wherein said upper portion comprises male connectors corresponding to female connectors of said lower saddle portion.

6. The split saddle assembly of claim 3 wherein said upper portion comprises female connectors corresponding to male connectors of said lower saddle portion.

7. The split saddle assembly of claim 3 wherein said upper portion comprises both male and female connectors corresponding to the male and female connectors of said lower saddle portion.

8. The assembly of claim 7 wherein said upper saddle section further comprises an integrated pipe fitting neck having an internal threaded surface for coupling pipe fittings.

9. The assembly of claim 7 wherein said upper saddle section further comprises an integrated pipe fitting neck having an external threaded surface.

10. The assembly of claim 7 wherein said upper saddle section further comprises an integrated pipe fitting neck having a barb connection.

11. The assembly of claim 7 wherein said upper and lower saddle sections further comprise an integrated pipe fitting neck having a barb connection.

12. The assembly of claim 7 wherein said upper and lower saddle sections further comprise an integrated pipe fitting neck having an internal threaded surface for coupling pipe fittings.

13. The assembly of claim 7 wherein said upper and lower saddle sections further comprise an integrated pipe fitting neck having an external threaded surface.

14. The assembly of claim 13, wherein each extension is split into two parts and each of said upper and lower saddle sections comprises a part, such that each extension is formed upon joining of said upper and lower saddle sections.

15. A method of coupling pipe using a threadable split saddle assembly comprising:
placing upper saddle portion against the main pipe;
placing lower saddle portion against the main pipe;
aligning the lower and upper saddle portions over main pipe with the female and male connectors; and
fastening the upper and lower saddle portions by using a plurality of fasteners at parallel sides of the split saddle.

16. The method of claim 15 further comprising:
fitting a branched pipe fitting on at least one of the upper or lower saddle portions.

17. The method of claim 15, wherein said fastener comprises a wing nut.

18. A split saddle pipe coupling assembly comprising a plurality of saddle portions each having externally threaded extensions and a fastener for fastening said extensions.

19. A split saddle pipe coupling assembly wherein each saddle portion comprises a plurality of externally threaded extensions and corresponding fasteners for fastening said extensions.

20. The split saddle pipe coupling assembly of claim 19 wherein said plurality of externally threaded extension comprises four externally threaded sections on each saddle portion and four corresponding fasteners.

21. The split saddle pipe coupling assembly of claim 19 wherein said plurality of externally threaded extensions comprises two externally threaded sections on each saddle portion and corresponding fasteners.

22. A split saddle pipe coupling assembly comprising a plurality of portions joined by a hinge, an externally threaded extension attached to said portions, and a fastener for fastening said extension, wherein said extension is located at an opposite side of said portions from said hinge.

23. The split saddle pipe assembly of claim 1 wherein said fastener has an increasing diameter.

24. The assembly of claim 23 wherein said fastener has a conical shape

25. The assembly of claim 24 wherein said fastener is a wing nut.

26. The fastener of claim 25 comprising gear work teeth.

27. A coupling assembly for coupling at least two corresponding portions of a structure comprising
a. an upper portion having an extension for coupling said structure;
b. a lower portion having an extension for coupling said structure;
c. a fastener to externally fasten said extensions of said upper and lower structure portions.

28. The coupling assembly of claim 27 wherein said extensions are externally threaded and wherein said fastener comprises a nut having corresponding threading on its internal surface.

29. The coupling assembly of claim 28 wherein said upper portion and said lower portions each further comprise two external threaded extensions that are on parallel sides of the structure body and extend perpendicularly to the structure body; and wherein each of said two external threaded extensions comprise a corresponding fastener.

30. A coupling assembly for coupling at least two corresponding portions of a structure comprising at least one conically shaped split bolt construct having external threading and a corresponding nut comprising internal conical threading corresponding to said external threading for coupling said at least two portions of said structure.

31. The coupling assembly of claim 30 wherein said split bolt construct comprises a first split bolt member and a second split bolt member each corresponding with the other to form said split both construct; and wherein each of said first and second split bolt members are disposed on one of said two portions of said structure.

32. The coupling assembly of claim 30 wherein said split bolt constructs forms a pair of male joining members and wherein said nut comprises a female coupling member.

33. The coupling assembly of claim 30 wherein said split bolt construct forms at least two and up to four male joining members and wherein said nut comprises a female coupling member.

34. The coupling assembly of claim 30 wherein said nut further comprises gear work teeth disposed on its external or internal surface.

35. The coupling assembly of claim 33 wherein said gear work teeth associate with a corresponding stopper member disposed on a surface chosen from the group consisting of at least one portion of said coupling structure and at least a portion of said split bolt construct.

36. The coupling assembly of claim 34 wherein said gear work teeth are disposed on the internal surface of said nut such that said teeth point internally.

37. The coupling assembly of claim 34 wherein said gear work teeth are disposed on the external surface of said nut such that said teeth point externally.

38. The coupling assembly of claim 34 wherein said gear work teeth are disposed on the external surface of said nut such that at least one or more of said teeth point externally and at least one or more of said teeth point internally.

39. The coupling assembly of claim 34 wherein said gear work teeth are disposed on the internal surface of said nut such that at least one or more of said teeth point externally and at least one or more of said teeth point internally.
